(19) United States
(12) Patent Application Publication
(10) Pub. No.: US 2013/0120743 A1
(43) Pub. Date: May 16, 2013

(54) Integrated Surface Plasmon Resonance Sensor

(71) Applicants: Burak Turker, Ankara (TR); Hasan Guner, Ankara (TR); Okan Oner Ekiz, Ankara (TR); Aykutlu Dana, Ankara (TR)

(72) Inventors: Burak Turker, Ankara (TR); Hasan Guner, Ankara (TR); Okan Oner Ekiz, Ankara (TR); Aykutlu Dana, Ankara (TR)

(21) Appl. No.: 13/702,564

(22) PCT Filed: Jun. 7, 2011
(86) PCT No.: PCT/TR11/00138

§ 371 Date: Dec. 6, 2012

(30) Foreign Application Priority Data
Jun. 7, 2010 (TR) 2010/04544

(51) Int. Cl. G01N 21/55

(52) U.S. Cl. CPC G01N 21/554
USPC 356/128

(57) ABSTRACT

Plasmon-integrated sensing mechanism comprised of three fundamental parts: a grating structure (2) with a specific metalization thickness (1) for the coupling of photons with the surface plasmons; a fluidic channel structure (4) in which liquid solutions with different refractive indexes will be streamed; and a photo-sensitive substrate (3) that can detect the light (8) which encounters changes in its intensity as the result of excitation of surface plasmons. The photo-sensitive substrate (3) may work according to photo-diode principle or it may work according to plasmon-assisted photo-resistor principle by using thin film amorphous carbon which exhibits resistance change sensitive to temperature.

This invention is related to a Nano-optoelectronic integrated detection mechanism that operates based on the Surface Plasmon Resonance (SPR) principle, uses a diffraction grating structure which is optimized to serve as energy coupler, has an integrated fluidic channel structure over the diffraction grating structure which is coated with a thin metal film layer, that makes measurement using an integrated photo-sensitive read-out unit, and that sensitively measures small changes in the refractive indices of liquids comprising different compounds which may be streamed within the fluidic channel.

The known plasmon resonance sensors mainly differ from each other by the optical coupling elements they use. Apart from the sensor mechanisms which use the diffraction grating structures mentioned in this invention, there are systems that use a prism or wave guide as the energy coupler. It has been stated in scientific literature that SPR sensors utilizing prism couplers result in higher sensitivity values compared to those employing other coupling methods. However, the prism that needs to be integrated into the sensing mechanism is bulky in its nature and this fact complicates miniaturization of the system. Problems with waveguide-based systems that use fibers include the requirement of using expensive prisms which have higher indices of refraction and that the potential for unstable sensitivity responses due to deformations in the fiber over the course of time. For these reasons and due to their compact size, planar structure and stability, grating couplers are superior in comparison with prism and waveguide-based couplers. Using the sensing mechanism described in this invention, small changes in the refractive index of the medium may be read out with high sensitivity by integrating a planar detector substrate with an optimized surface that creates grating coupled plasmons. The sensing mechanism disclosed herein thus uses the enhanced transmission that results as its detection scheme.

The integrated detection mechanism in certain embodiments is described below in conjunction with the accompanying drawings of which:

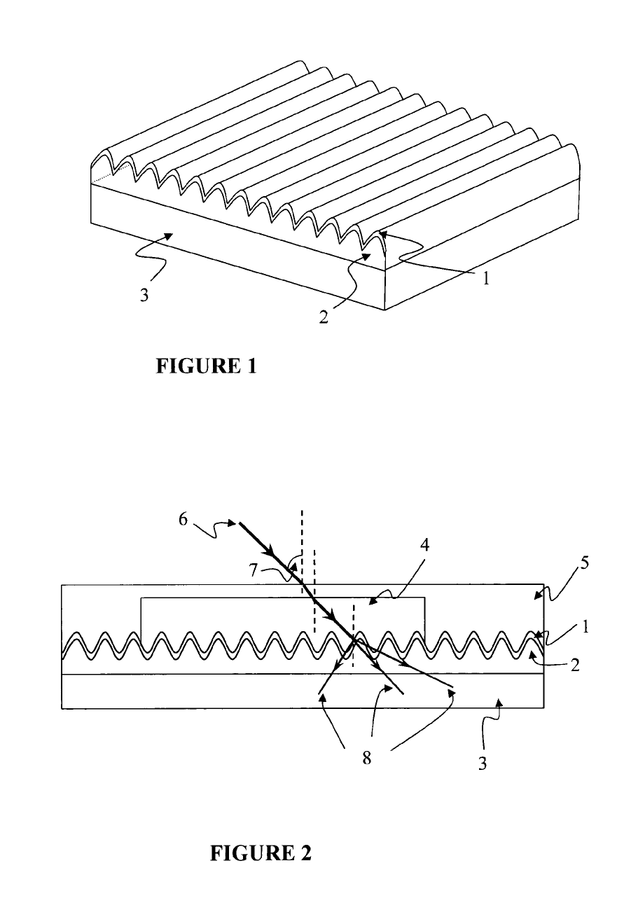

FIG. 1 depicts the layers of the plasmon resonance exciting system whose photo-sensitive bottom layer provides sensing functionality.

FIG. 2 is the front sectional view of the elements comprising the embodiment of FIG. 1.

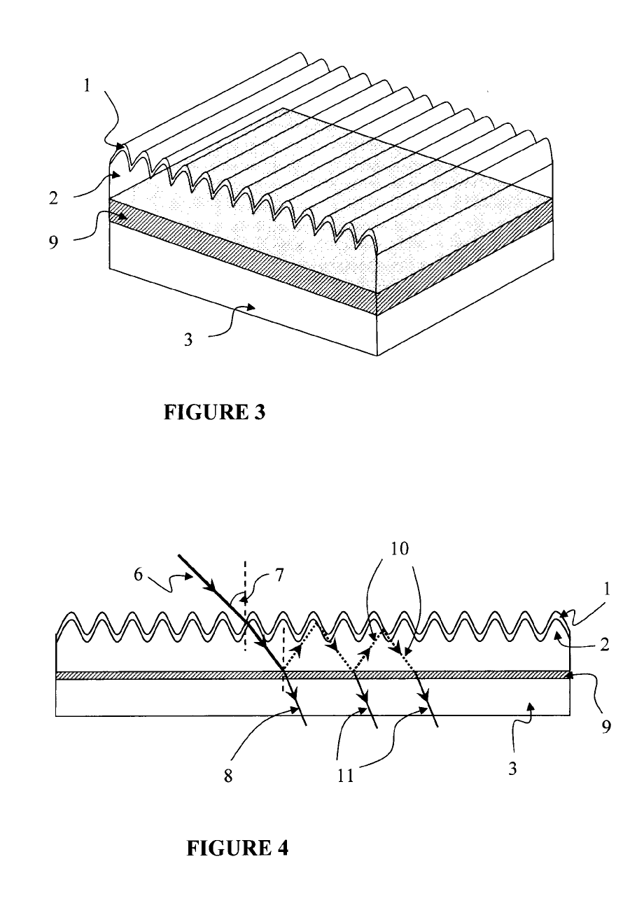

FIG. 3 depicts an embodiment in which the sensing system layers provide plasmonic enhancement through the Fabry-Pèrot effect, which is generated by placement of a reflective surface beneath the grating structure.

FIG. 4 depicts a cross-sectional view of the embodiment of FIG. 3 mechanism.

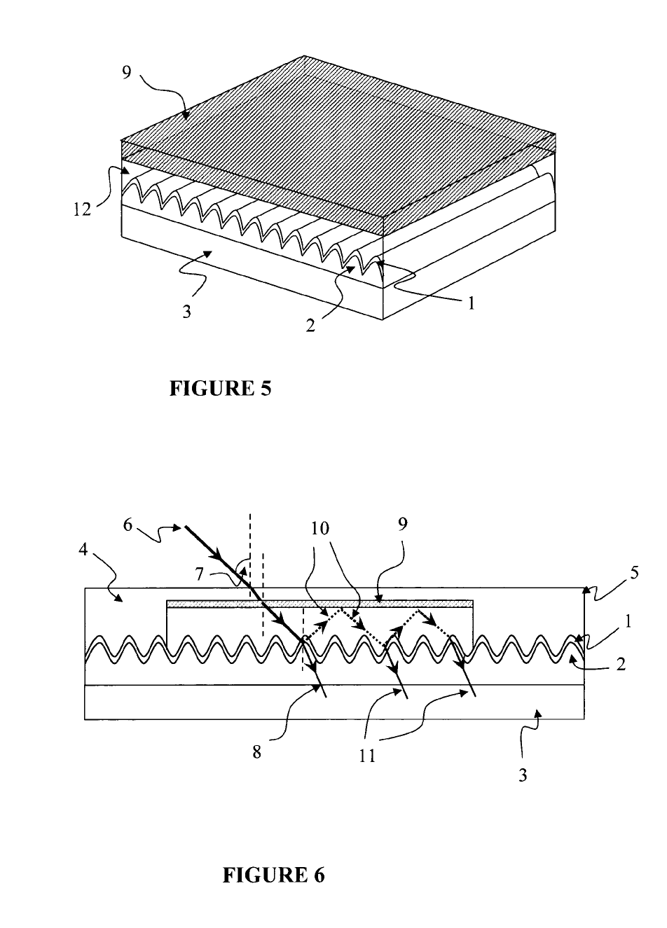

FIG. 5 depicts an embodiment that is an alternative to the embodiment of FIG. 3 in which the Fabry-Pèrot effect is generated within the sensing mechanism.

FIG. 6 depicts a cross-sectional view of the embodiment of FIG. 5.

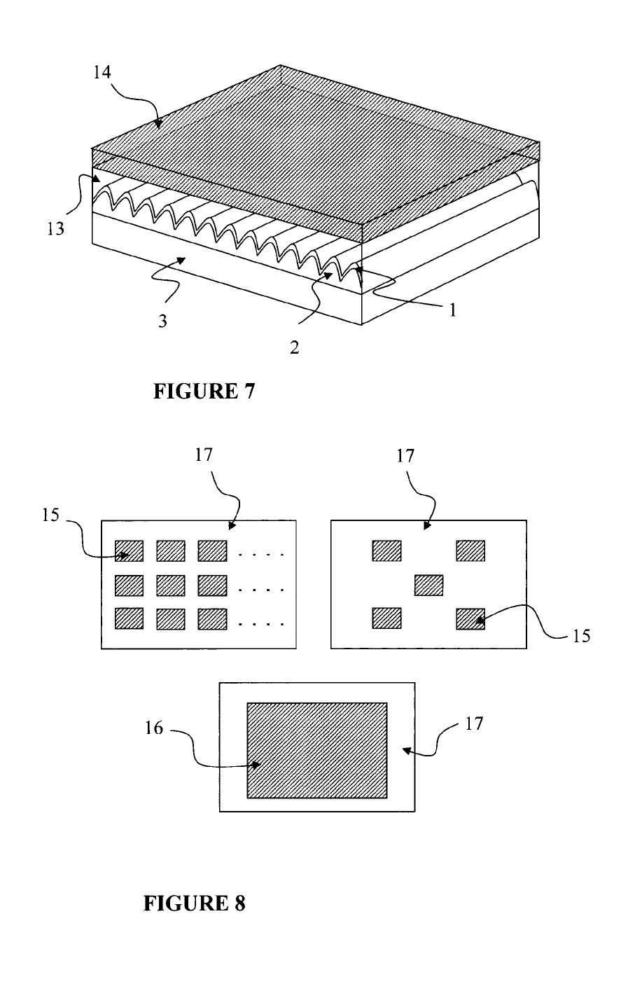

FIG. 7 depicts the layer structure of an embodiment whose optical properties can be thermally or electrically tuned, and that in particular illustrates the integration of the electrode into the grating structure.

FIG. 8 depicts an embodiment in which photo-sensitive regions are placed on the substrate in different geometrical positions and array-forms.

References in the figures are numbered and their equivalences are as indicated below.
1) Layer having a thin metal coating,
2) Optical element that is optimized and then shaped out of a transparent polymer (the grating structure),
3) Electronic sensor substrate that includes photo-diode or photo-resistive elements,
4) Fluidic channel cavity (the medium which has the refractive index of the streaming liquid within the channel),
5) Layer made of a rigid and transparent plastic material in which the fluidic channel is formed,
6) Beam from an external light source,
7) Angle of incidence of the beam that is required to excite the plasmonic resonance,
8) Beams that reach the photo-sensitive substrate by refracting from the grating surface,
9) Metalized surface with the reflecting feature,
10) Beams that encounter an internal reflection from the reflective metalized surface,
11) Beams that reach the photo-sensitive substrate after encountering internal reflection,
12) Transparent polymer or glass layer,
13) A layer whose optical properties can be tuned thermally or electrically,
14) Voltage applicable contact layer, i.e. electrode,
15) Regions with photo-diode or photo-resistive properties which can be arrayed in a desired manner and whose geometry and position can be designed according to the region of interest for sensing,
16) Monolithic sensing area with photo-diode or photo-resistive properties whose geometry and position can be designed according to the region of interest for sensing,
17) Glass or polymer substrate upon which the sensing mechanism is placed.

The plasmon integrated sensing mechanism uses the grating structure (2) as an optimized optical component, in order to couple the energy carried by the photons from an external certain-wavelength light source (6) that are incident upon the electrons located within a thin film metal layer (1). This energy transfer can only occur when the momentum mismatch between the incoming photons and the surface electrons upon which these photons are incident is eliminated by the coupling. For a certain angle of incidence of light (7) for which the light can couple to the metal surface (1), a group of excited electrons (i.e., surface plasmons) are generated within the metal layer that act as a single electrical entity. Oscillation of the charge density at the interface of the two different media (4 and 1) that have opposite-signed dielectric constants generates the surface plasmon resonance. At resonance, the light source (6) whose photons (and consequently whose energy) are absorbed by the metal surface (1) propagate (8) towards the photo-sensitive substrate (3) at the bottom layer of the device through the metalized grating surface (2) without encountering any back reflection.

The charge density wave that is generated at resonance reaches its highest amplitude at the interface between media which have different refractive indices (4 and 1). Furthermore, this wave attenuates exponentially in each of the two media. This generates an electrical field up to a certain depth in the upward and downward directions of the metal surface (1). Any change that may occur in the refractive index of the fluidic media (4) located within this plasmonic area results in variations of the resonance angle (7) of the incoming light (6) with respect to the surface plasmons. Thus, changes that occur in the refractive index of any liquid within the fluidic channel (4) that is formed within rigid and transparent plastic cover (5) create shifts in the resonance angle (7) of the incident light (6). Therefore, quantitative information can be obtained regarding the change of the medium's refractive index by real-time and precise measurement of the change in the amount of light (8) that propagates through to the photo-sensitive substrate (3).

The Fabry-Pèrot effect may be exploited in two different classes of embodiments of the integrated sensing device that provide enhanced measurement sensitivity by augmenting the amount of light (8) reaching the photo-sensitive layer (3). In the first design class (embodiment of which is depicted in FIGS. 3-4), a thin metal coated reflective layer (9) is placed between the metal coated (1) grating structure (2) and the photo-sensitive substrate (3). In this case, the measurable SPR (surface plasmon resonance) sensitivity can be enhanced due to the multiplexed beam (11) that is generated as a result of internal reflections of the Fabry-Pèrot effect (10) and classical diffraction (8) that propagates through to the photo-sensitive substrate (3).

In the second design class, the thin metal coated reflective layer (9), which generates the Fabry-Pèrot effect, is located on a polymer or glass layer (12) which is placed on the metal coated (1) grating structure (2).

On the substrate (17) where the sensing mechanism will be placed on, with the purpose of performing different readings at different locations, the photo-sensitive layer (3) can be produced customized with different geometrical placement-arrays (15) or with a single-parted detection area (16) to read-out at a single region.

Photo-sensitive layer (3) may be customized in a few different geometrical configurations as depicted in FIG. 8. For purposes of location-dependent read-out, photo-sensitive detecting areas (15) of various geometries may be located on the substrate (17), or for purposes of single-region read-out, a single large photo-sensitive detecting area (16) may be configured on the substrate (17).

By forming a layer (13) over grating structure (2) whose optical properties can thermally or electrically be changed, and then by forming electrode (14) for purposes of application of voltage, a medium (13) whose refractive index is tunable via voltage application may be produced.

1.-9. (canceled)

10. A plasmon-integrated sensing mechanism:
allowing an excitation of a surface plasmon resonance (SPR) in case of targeting a certain-wavelength-light source with a specific angle of incidence onto an optimized grating structure (2) that has a certain thin metal film deposition (1);
quantitatively measuring the changes occurred in a medium's (4) refraction index by sensitively detecting this excitation amount via its photo-sensitive substrate (3);
allowing high a miniaturization and high-density integration at the result of its planar design and its production techniques used.

11. A plasmon-integrated sensing mechanism according to claim 10, comprising an integrated fluidic channel structure (4), made of a rigid transparent plastic or glass that can be mounted on to the surface via a gasket.

12. A plasmon-integrated sensing mechanism according to claim 10, comprising an integrated fluidic channel structure (4) made of a completely transparent elastomeric material which can be patterned lithographically and so that not to require a gasket.

13. A plasmon-integrated sensing mechanism according to claim 10, which enhances a measurable SPR sensitivity by augmenting an amount of light reaching to the photo-sensitive substrate (3) utilizing multiplexed beams (11) coming from internal reflections (10) as a result of a Fabry-Pèrot effect that is created via a thin metal film coated reflective surface (9) that is placed beneath the grating structure (2).

14. A plasmon-integrated sensing mechanism according to claim 11, which enhances a measurable SPR sensitivity by augmenting an amount of light reaching to the photo-sensitive substrate (3) utilizing multiplexed beams (11) coming from internal reflections (10) as a result of a Fabry-Pèrot effect that is created via a thin metal film coated reflective surface (9) that is placed beneath the grating structure (2).

15. A plasmon-integrated sensing mechanism according to claim 12, which enhances a measurable SPR sensitivity by augmenting an amount of light reaching to the photo-sensitive substrate (3) utilizing multiplexed beams (11) coming from internal reflections (10) as a result of a Fabry-Pèrot effect that is created via a thin metal film coated reflective surface (9) that is placed beneath the grating structure (2).

16. A plasmon-integrated sensing mechanism according to claim 10, which creates a Fabry-Pèrot effect that enhances a measurable SPR sensitivity by the help of a thin metal film coated reflective surface (9) located on a transparent polymer or glass layer (12) which is placed on the metalized (1) grating structure (2).

17. A plasmon-integrated sensing mechanism according to claim 11, which creates a Fabry-Pèrot effect that enhances a measurable SPR sensitivity by the help of a thin metal film coated reflective surface (9) located on a transparent polymer or glass layer (12) which is placed on the metalized (1) grating structure (2).

18. A plasmon-integrated sensing mechanism according to claim 12, which creates a Fabry-Pèrot effect that enhances a measurable SPR sensitivity by the help of a thin metal film coated reflective surface (9) located on a transparent polymer or glass layer (12) which is placed on the metalized (1) grating structure (2).

19. A plasmon-integrated sensing mechanism according to claim 10, comprising the photo-sensitive substrate (3) that can variously be patterned in different geometrical pattern and array forms (15, 16), in order to create different measurement regions according to interest.

20. A plasmon-integrated sensing mechanism according to claim 11, comprising the photo-sensitive substrate (3) that can variously be patterned in different geometrical pattern and array forms (15, 16), in order to create different measurement regions according to interest.

21. A plasmon-integrated sensing mechanism according to claim 12, comprising the photo-sensitive substrate (3) that can variously be patterned in different geometrical pattern and array forms (15, 16), in order to create different measurement regions according to interest.

22. A plasmon-integrated sensing mechanism according to claim 10, having a photo-resistor or photo-diode based light detection principle (3).

23. A plasmon-integrated sensing mechanism according to claim 11, having a photo-resistor or photo-diode based light detection principle (3).

24. A plasmon-integrated sensing mechanism according to claim 12, having a photo-resistor or photo-diode based light detection principle (3).

25. A plasmon-integrated sensing mechanism according to claim 10, comprising a detection substrate (3) which is made of a layer that can sense by changing its resistance being sensitive to temperature.

26. A plasmon-integrated sensing mechanism according to claim 19, comprising a detection substrate (3) which is made of a layer that can sense by changing its resistance being sensitive to temperature.

27. A plasmon-integrated sensing mechanism according to claim 22, comprising a detection substrate (3) which is made of a layer that can sense by changing its resistance being sensitive to temperature.

28. A plasmon-integrated sensing mechanism according to claim 10, which makes the medium's index controllable by applying an external voltage with its structure that is containing a layer (13) whose optical properties can thermally and electrically be tuned; and with its structure that is creating the required contact area (14) for the voltage application.

29. A plasmon-integrated sensing mechanism according to claim 11, which makes the medium's index controllable by applying an external voltage with its structure that is containing a layer (13) whose optical properties can thermally and electrically be tuned; and with its structure that is creating the required contact area (14) for the voltage application.
